(19) United States
(12) Patent Application Publication
(10) Pub. No.: US 2006/0261513 A1
(43) Pub. Date: Nov. 23, 2006

(54) Manufacturing method of carrier

(75) Inventor: Duk-Geun Yoon, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 11/320,829

(22) Filed: Dec. 30, 2005

(30) Foreign Application Priority Data
May 4, 2005 (KR) 2005-37688

(51) Int. Cl. B27N 3/08; B29C 53/00; B29C 51/00; B28B 19/00

(52) U.S. Cl. 264/239

(57) ABSTRACT

A manufacturing method of a hybrid-carrier includes injection-molding the hybrid-carrier, solidifying the injection-molded hybrid-carrier by cooling it down, making holes in the solidified hybrid-carrier to attach other parts to the hybrid-carrier, and mounting nuts on the hybrid-carrier in which the holes are made. The hybrid-carrier is manufactured by the above method in that holes are made in and nuts are mounted on the hybrid-carrier whose deformation is already complete even if the hybrid-carrier undergoes deformation during the process of solidification after being injection molded, thereby minimizing the errors and corrections when mounting other parts to the hybrid-carrier.

### RELATED APPLICATIONS

The present disclosure relates to subject matter contained in Korean Application No. 10-2005-37688, filed on May 4, 2005, which is herein expressly incorporated by reference in its entirety.

### BACKGROUND OF THE INVENTION

1. Field of the Invention

The present invention relates to a manufacturing method of a hybrid-carrier, made of plastic and steel, which undergoes deformation after injection-molding, wherein the holes for assembling the parts that are to be mounted on the hybrid-carrier are drilled in the carrier, thereby correcting the dimensions of the holes precisely, and reducing the cost of manufacturing.

2. Description of the Related Art

In general, a vehicle frame, defining the outer appearance of a vehicle, comprises a passenger cabin, an engine compartment, a trunk compartment, fenders, and the like. The vehicle frame is divided into a front vehicle frame, a central vehicle frame, and a rear vehicle frame, in a lengthwise direction of the vehicle.

The front vehicle frame is provided with a carrier, which has a headlamp, a radiator, a condenser, a bumper, and the like assembled thereto. As for a technology for integrally assembling the headlamp, the radiator, the condenser, the bumper, and the like to a frame panel of the vehicle in order to enhance assembly efficiency at a jobsite, and to reduce the number of components to be assembled, thereby ensuring precise assembly thereof, an FEM (front-end module) is applied to such a carrier that is a hybrid type, wherein plastic and steel materials are coupled to each other.

FIG. 1 is a block view illustrating a conventional manufacturing process of hybrid-carrier. As shown in the drawings, the process of manufacturing a hybrid-carrier comprises a step 11 for forming the hybrid-carrier in accordance with the design drawing by injection molding, a step 12 for carrying out a nutserting process after the above step and a step 13 for cooling the molded hybrid-carrier.

That is, the hybrid-carrier is formed of plastic and steel materials in accordance with the shape of the vehicle by a carrier-molding process. And in the carrier-molding process, the holes for assembling the parts such as the headlamp, bumper cover and the like are drilled through at the same time.

And a nut is fixed in each of the above holes during the nutserting process, thereby assembling other parts by bolting.

When the nutserting process is complete as shown above, then, the molded hybrid-carrier is cooled down, thereby reducing its load, and a carrier of hybrid type which is both light and solid is, then, formed.

However, there are problems with the manufacturing process described above as follow.

Firstly, since the holes for assembling the headlamp or bumper with the hybrid-carrier in the injection molding process are undercut parts in the pullout direction of the injection mold, there is a problem in that the injection molding process becomes complicated with the need of applying a slide core to it.

Secondly, as the deformation of the molded hybrid-carrier occurs by undergoing a cooling process after the holes for assembling the parts are drilled through, there is a problem in that a gap or divergence in heights with the parts is formed and the dimensions of the holes are changed.

Thirdly, as the deformation of the molded hybrid-carrier occurs before the carrier is completely solidified during the cooling process after injection-molding process, there is a problem in that the percentage of faulty products is increased with the occurrence of diffusion of air-bubbles in the holes during nutserting process.

Fourthly, due to the deformation of the hybrid-carrier shown above, there is a problem in that the time taken to maximize the quality of products is lengthened by the errors in the shape of the hybrid-carrier and the incorrect elevation of injecting.

Lastly, since an additional correction device with sensor is required in order to correct the gap or divergence in heights due to deformation of the hybrid-carrier, there is a problem in that such a correction device is expensive which makes the cost of manufacturing higher.

### SUMMARY OF THE INVENTION

The present invention has been made to solve the above problems, and it is an object of the present invention to enable more precise manufacturing of a hybrid-carrier, which minimizes the gap or divergence in heights that occurs when assembling other parts by drilling holes for assembling the parts after the carrier is completely solidified under cooling.

In accordance with an aspect of the present invention, the above and other objects can be accomplished by process for providing a hybrid-carrier, the steps of: comprising: injecting and molding the hybrid-carrier, solidifying the injection-molded carrier by cooling it down, making holes in the solidified hybrid-carrier to assemble other parts to the hybrid-carrier and fixing nuts to the hybrid-carrier in the holes.

The manufacturing method of hybrid-carrier has its holes made in and the nuts fixed in the carrier which has undergone a complete deformation, thereby minimizing the errors or corrections when attaching other parts to the hybrid-carrier even if the hybrid-carrier undergoes deformation during the process of solidification after being injection-molded.

### BRIEF DESCRIPTION OF THE DRAWINGS

The foregoing and other objects and features of the present invention will be more clearly understood from the following detailed description taken in conjunction with the accompanying drawings, in which:

FIG. 1 is a block view illustrating a conventional manufacturing process of hybrid-carrier.

FIG. 2 is a block view illustrating a manufacturing process of carrier according to the present invention

FIG. 3 is a diagram illustrating the use of correction nuts in order to correct the dimension of the holes in the hybrid-carrier according to the present invention

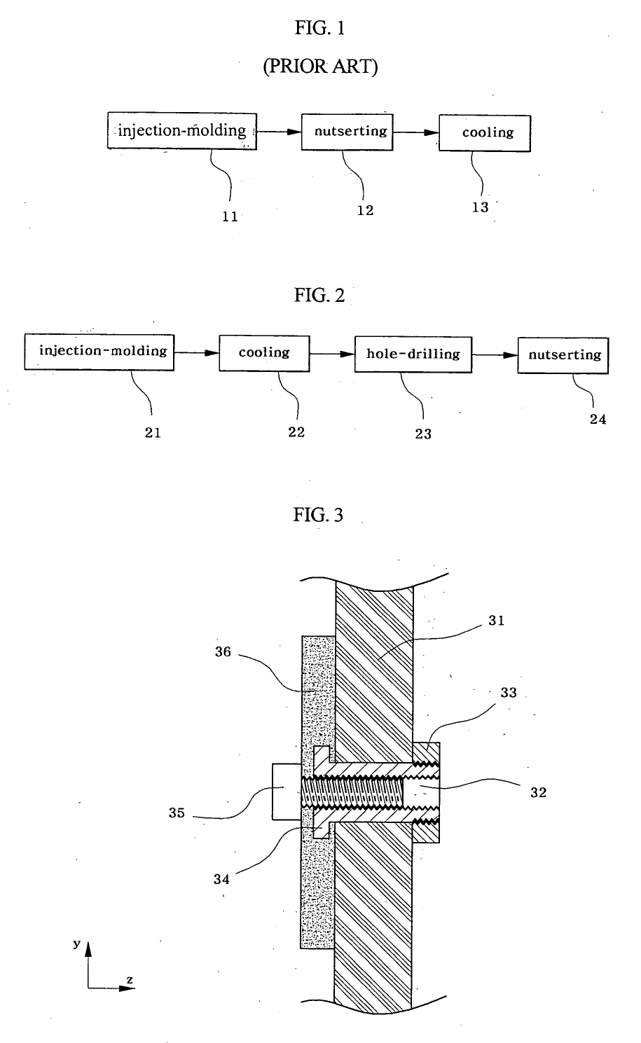

### DESCRIPTION OF THE PREFERRED EMBODIMENTS

Preferred embodiments will now be described in detail with reference to the accompanying drawings.

Further, in the following description, the present embodiments are disclosed for example only, and not to limit the scope of the present invention. The same components as those of the conventional manufacturing method of hybrid-carrier will be denoted by the same reference numerals.

FIG. 2 is a block view briefly illustrating a manufacturing process of hybrid-carrier according to the present invention,

As shown in the drawings, the manufacturing method of hybrid-carrier according to the present invention comprises of steps, wherein the outer shape of the hybrid-carrier is injection-molded first 21, then, the injection-molded hybrid-carrier is solidified by cooling it down 22, holes for assembling the parts are made in the solidified hybrid-carrier above 23, and nuts are fixed in the hybrid-carrier in which the holes have been made.

That is, to describe the manufacturing process of a hybrid-carrier according to the present invention in detail, a hybrid-carrier according to each model of different kinds of vehicles is injection-molded in the first step, but holes for assembling the parts to the injection-molded carrier as in case of the conventional method are not made at this step.

Since such holes are not made at the injection molding step and, therefore, the application of a slide core is excluded, the injection molding process can be simplified and the cost can be reduced.

The hybrid-carrier, which is injection-molded as shown above, undergoes a deformation which is a characteristic of plastic materials since the plastic mold from injection molding is solidified through the cooling process, which is the second step, and the operator is recommended to take into account of the rate of such deformation when carrying out the injection molding process of the hybrid-carrier

And holes for attaching the parts such as the headlamp, bumper cover and the like to the hybrid-carrier, which has been solidified by undergoing partial deformation through the second step, are made at the exact locations which have been designed previously.

That is, the present invention lowers the percentage of faulty products by making the holes in the solidified hybrid-carrier whose deformation is already completed; which occurs due to errors in the locations and dimensions which are different from the initial design because of deformation after the holes are made, in the case of the hybrid-carrier according to the injection molding of the conventional hybrid-carrier.

As a fourth step, after going through the stages where the holes are made in the hybrid-carrier above, a nutserting process which inserts the nuts into the holes above is carried out

Such a nutserting process assembles the nuts with the bolts fixing the parts to the hybrid-carrier, wherein either additional nuts are placed inside the inner part of the holes in the hybrid-carrier or the holes are made threaded.

Meanwhile, when the holes are made in the manufacturing method as shown above, the positions in the x and y directions with the front face of the hybrid-carrier being the basis of an x-y-z coordinate system can be precisely set, however, the z-direction requires some corrections.

In order to carry out such corrections in the z-direction, it is recommended to use correction nuts, and FIG. 3 is a diagram illustrating the use of a correction nut in order to correct a hole in the hybrid-carrier.

As shown in the drawings, a nut 33 is fixed on the hybrid-carrier 31 by the nutserting process and placed in the hole which is made in after the deformation and solidification of the hybrid-carrier 31 are complete.

Here, the above hole 32 in the hybrid-carrier, whose deformation is complete, is made accurately in the x and y direction according to the design drawing, but there can be errors in the z-direction.

Therefore, in order to carry out corrections in the z-direction, the correction nut 34 penetrates the hole 32 and is put together with the nut 33, thereby correcting the position in the z-direction, and fixing the parts 36 to the hybrid-carrier 31 with the bolt 35 by putting them closely together.

As is apparent from the above description, according to the present invention, there are advantageous effects in that the manufacturing method of hybrid-carrier allows the holes to be made when the deformation is completed after the hybrid-carrier has been injection-molded, thereby reducing the percentage of errors in the holes and weight of the carrier and enhancing the coupling.

And, in case of the conventional injection molding of hybrid-carrier, a slide core is applied in order to form the holes, however, according to the present invention, since the holes are made in after the injection molding and deformation of the hybrid-carrier are completed, the application of a slide core is excluded, thereby accomplishing the simplification of injection molding process, and there are advantageous effects such as the reduction in manufacturing costs or the removal of core parting lines.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims.

1. A method for manufacturing a hybrid-carrier, comprising;
Injecting and molding the hybrid-carrier;
cooling down and solidifying the molded hybrid-carrier;
making holes in the molded hybrid-carrier after the molded hybrid-carrier is solidified completely; and
mounting nuts to the holes of the molded hybrid-carrier.

2. The method for manufacturing a hybrid-carrier as set forth in claim 1, wherein correction nuts are further mounted in the holes in order to correct the dimensions of the holes.
